(19) United States
(12) Patent Application Publication
(10) Pub. No.: US 2013/0115328 A1
(43) Pub. Date: May 9, 2013

(54) MICROENCAPSULATED PROBIOTICS FOR REDUCING FECAL SHEDDING OF PATHOGENIC MICROBES IN ANIMALS

(71) Applicants: Azlin Mustapha, Columbia, MO (US); Monty Kerley, Columbia, MO (US); Juhee Ahn, Chuncheon-si (KR)

(72) Inventors: Azlin Mustapha, Columbia, MO (US); Monty Kerley, Columbia, MO (US); Juhee Ahn, Chuncheon-si (KR)

(73) Assignee: The Curators of the University of Missouri, Columbia, MO (US)

(21) Appl. No.: 13/559,361

(22) Filed: Jul. 26, 2012

Related U.S. Application Data
(60) Provisional application No. 61/512,322, filed on Jul. 27, 2011.

(51) Int. Cl. A23K 1/16

(52) U.S. Cl. CPC A23K 1/16
USPC 426/2; 426/61

(57) ABSTRACT

Disclosed are methods and compositions for reducing E. coli O157:H7 colonization and shedding in ruminant animals. In certain aspects, methods are provided comprising delivering microencapsulated probiotic bacteria to the gastrointestinal tract of a ruminant animal. Microencapsulated probiotics for delivery to the gastrointestinal tract of a ruminant animal in order to reduce E. coli O157:H7 shedding are also provided.

This application claims the benefit of priority of U.S. Provisional Application No. 61/512,322, filed on Jul. 27, 2011, the entire disclosure of which is incorporated herein by reference.

### BACKGROUND OF THE INVENTION

I. Field of the Invention

The present invention relates generally to the field of animal sciences. More specifically, the invention relates to methods and compositions for providing probiotics to the gastrointestinal tract of an animal.

II. Related Art

Escherichia coli, and in particular the strain O157:H7, has continued to be an emerging cause of human diseases over the past two decades, leading to hemorrhagic colitis, hemolytic uremic syndrome, and thrombotic thrombocytopenic purpura. The prevalence of E. coli O157:H7 in domestic animals has potential direct impacts on human health because feed animals, such as cattle, are well known as the primary reservoir of this food borne pathogen, where the pathogen can harbor, reproduce, and be excreted. Animal feces are a potential source of E. coli O157:H7 contamination to the environment and food. Fecal shedding of E. coli O157:H7 may play a key role in the increased risk of infection to humans. Therefore, reducing or eliminating the carriage of this pathogen in domestic feed animals can potentially decrease cross-contamination during slaughter.

### SUMMARY OF THE INVENTION

In one aspect, the invention provides a method for delivering probiotic bacteria to the gastrointestinal tract of a ruminant animal comprising providing at least one probiotic bacterium encapsulated in carrageenan in the diet of a ruminant animal. In certain embodiments, the ruminant animal is selected from the group consisting of a cow, a goat, a sheep and a deer.

In one embodiment, the probiotic bacteria are delivered to the post rumen portion of the gastrointestinal tract of the ruminant animal. It may be beneficial to deliver the probiotic bacteria to the portion of the gastrointestinal tract in which pathogenic bacteria colonize. For instance, in one embodiment, the invention provides delivery of the probiotic bacteria to the portion of the gastrointestinal tract colonized by E. coli, such as O157:H7. In a particular embodiment, the probiotic bacteria are delivered to the terminal rectum or the recto-anal junction. In another embodiment, delivery of the probiotic bacteria to the gastrointestinal tract of the ruminant animal may reduce E. coli colonization in the gastrointestinal tract.

In certain embodiments, the probiotic bacteria comprise bacteria from at least one species selected from the group consisting of: Lactobacillus paracasei, Lactobacillus acidophilus, Lactobacillus rhamnosus, Bifidobacterium animalis, and Bifidobacterium bifidum. In specific embodiments, the probiotic bacteria comprise Lactobacillus paracasei or Bifidobacterium animalis bacteria or may comprise Lactobacillus paracasei and Bifidobacterium animalis bacteria. In a particular embodiment, the probiotic bacteria are suspended in a saline solution.

In one embodiment of the method, the probiotic bacteria to be delivered to the ruminant animal are spread on the top of the daily feed of the ruminant animal. Alternatively, the probiotic bacteria may be mixed into the daily feed of the ruminant animal to which they are being delivered. In another embodiment, the probiotic bacteria are provided in the diet of the ruminant animal at 10¹⁰ colony forming units (CFU) per day. In certain embodiments, the probiotic bacteria may be provided in an amount of about 10⁵, 10⁶, 10⁷, 10⁸, 10⁹, 10¹⁰, 10¹¹, 10¹², 10¹³, 10¹⁴ or 10¹⁵ colony CFU per day. In yet another embodiment, the probiotic bacteria are delivered to the ruminant animal between 2 and 44 days, for instance for 2, 3, 4, 5, 6, 7, 8, 9, 10, 11, 12, 13, 14, 15, 16, 17, 18, 19 20, 21, 22, 23, 24, 25, 26, 27, 28, 29, 30, 31, 32, 33, 34, 35, 36, 37, 38, 39, 40, 41, 42, 43 or 44 days. In another embodiment, the probiotic bacteria are delivered to the ruminant animal daily. In a still another embodiment of the invention, the probiotic bacteria are provided in the diet of the ruminant animal prior to slaughter. In particular embodiments, the probiotic bacteria may be provided in the diet of the ruminant animal 44, 42, 40, 35, 30, 25, 20, 19, 18, 17, 16, 15, 14, 13, 12, 11, 10, 9, 8, 7, 6, 5, 4, 3, 2 or 1 day before slaughter.

In another aspect, the invention provides a method of reducing E. coli in the gastrointestinal tract of a ruminant animal comprising delivering at least one probiotic bacteria encapsulated in carrageenan in the diet of a ruminant animal. In one embodiment, the ruminant is selected from the group consisting of a cow, a goat, a sheep and a deer. In another embodiment the E. coli being reduced is E. coli O157:H7.

In another embodiment, the method comprises delivering the probiotic bacteria to the post rumen portion of the gastrointestinal tract of the ruminant animal, such as, the terminal rectum or the recto-anal junction. In another embodiment, delivery of the probiotic bacteria to the gastrointestinal tract of the ruminant animal may reduce E. coli, for instance E. coli O157:H7, colonization in the gastrointestinal tract.

In certain embodiments, the probiotic bacteria comprise bacteria from at least one species selected from the group consisting of: Lactobacillus paracasei, Lactobacillus acidophilus, Lactobacillus rhamnosus, Bifidobacterium animalis, and Bifidobacterium bifidum. In specific embodiments, the probiotic bacteria comprise Lactobacillus paracasei or Bifidobacterium animalis bacteria or may comprise Lactobacillus paracasei and Bifidobacterium animalis bacteria. In a particular embodiment, the probiotic bacteria are suspended in a saline solution.

In one embodiment of the invention, the probiotic bacteria may be delivered to the ruminant animal as a spread on the top of the daily feed of the ruminant animal. In another embodiment, the probiotic bacteria are provided in the diet of the ruminant animal at about 10¹⁰ CFU per day. In yet another embodiment, the probiotic bacteria are delivered to the ruminant animal for between 2 and 44 days and may be provided in the diet of the ruminant animal prior to slaughter.

In yet another aspect, the invention provides a probiotic bacterial composition encapsulated in carrageenan for use in a ruminant animal. In one embodiment, the probiotic bacterial composition that is encapsulated is selected from the group consisting of Lactobacillus paracasei, Lactobacillus acidophilus, Lactobacillus rhamnosus, Bifidobacterium animalis, and Bifidobacterium bifidum. In certain embodiments, the probiotic bacterial composition to be encapsulated comprises Lactobacillus paracasei or Bifidobacterium animalis bacteria or may comprise Lactobacillus paracasei and Bifidobacterium animalis bacteria. In a particular embodiment, the probiotic bacteria are suspended in a saline solution.

In another embodiment, the probiotic bacterial composition functions to reduce colonization of E. coli, such as E. coli O157:H7, in the gastrointestinal tract of the ruminant animal when provided in the diet of the ruminant animal. In another embodiment, the ruminant animal is selected from the group consisting of a cow, a goat, a sheep and a deer.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. Shows a comparison of two bifidobacterial strains survival in carrageenan and alginate capsules over 15 days. Carrageenan capsules resulted in a lower reduction in cell numbers over time than alginate capsules for both strains tested.

### DETAILED DESCRIPTION OF ILLUSTRATIVE EMBODIMENTS

The present invention concerns increasing the effectiveness of competitive exclusion (CE) microbes in animal diets and provides methods for delivery of competitive exclusion microbes or probiotics to the animal that competitively inhibit pathogen attachment, growth and differentiation at the gut level.

In particular, the invention provides a method of reducing pathogen invasion and shedding in ruminant animals, such as cattle, through the delivery of probiotic bacteria to the gastrointestinal tract of the ruminant animal. In one embodiment, the probiotic bacteria are encapsulated in a material, such as carrageenan, that maintains the viability of the probiotic bacteria through the rumen of the animal thereby allowing higher numbers of such bacteria to reach the lower gastrointestinal tract of the animal. Microencapsulated probiotic bacteria, as a feed supplement for instance, may contribute to increasing the safety of meat products by providing an effective alternative pre-harvest intervention technique for the industry.

In one embodiment, the present invention provides the use of the microencapsulated probiotics to reduce the E. coli O157:H7 shedding and colonization at the terminal rectum, including the recto-anal junction (RAJ). Recent studies found that the terminal rectum is the main site of localization of E. coli O157 in cattle (Low et al., Appl. Environ. Microbiol. 71:93-97, 2005; Naylor et al., Infection and Immunity 71:1505-1512, 2003; and Naylor et al., Microbiol. 151:2773-2781, 2005).

The contamination of animal food products with microbes that are pathogenic to humans occurs primarily via hide contact with the carcass. The hide contains fecal particles which harbor the pathogens. If dietary intervention can alleviate the pathogens from being shed from the gut with feces, the risk of the hide becoming contaminated with fecal pathogens will be significantly decreased, if not eliminated, thus reducing the risk of contamination of the finished meat.

Preventive and therapeutic approaches to reducing the prevalence of E. coli O157:H7 in feed animals previously include the use of antibiotics, acidification, vaccination and dietary restriction. Antibiotic and dietary controls can pose potential risks to human health resulting from an increased number of antibiotic and acid resistant pathogens (Fuller, J. Appl. Bacteriol. 66:365-378, 1989 and Meng et al., J. Food Prot. 61:1511-1514, 1998). In addition, the use of antibiotics and proper diet as control measures interferes with the maintenance of a proper balance of indigenous intestinal microflora in animals. The vaccine approaches are still limited to the effectiveness of antibodies in terms of a consistent immune response at the desired site, safety, cost, and environmental contamination (Bach et al., Can. J. Anim. Sci. 82:475-490, 2002). Another method used to prevent pathogen shedding in cattle requires the feeding of a hay only diet. Such an approach is not practical due to feeding management limitations and the effect that prolonged hay feeding would have on carcass composition.

As demonstrated in the Examples below, microencapsulated probiotic bacteria effectively decreased the E. coli O157:H7 shedding to levels detectable only by an enrichment culture at 30 and 44 days p.i. when compared to the controls and industry standard treatments. Additionally, no E. coli O157:H7 colonization in the terminal rectum was observed in cattle treated with microencapsulated probiotics. These results suggest that the feeding of microencapsulated probiotics is an effective pre-harvest intervention strategy to reduce the risk of E. coli O157:H7 by maintaining a balanced microflora in cattle and may provide many potential benefits in lieu of using other treatments, such as antibiotics. The present invention therefore provides an alternative approach for improving intestinal microbial balance.

### I. PROBIOTICS

A “probiotic” as used herein refers to a microorganism that naturally inhabits the intestinal tracts of animals and humans and that is considered non-pathogenic, safe, and health beneficial. See for example, Collado et al., Lett. Appl. Microbiol. 45:454-460, 2007 and Fuller, J. Appl. Bacteriol. 66:365-378, 1989. Such probiotics, according to one aspect of the invention, may comprise lactobacilli and bifidobacteria, which make up a dominant part of the intestinal microflora of humans and animals (Collins and Gibson, Am. J. Clin. Nutr. 69:1052S-1057S, 1999 and Corr et al., FEMS Immunol. Med. Microbiol. 50:380-388, 2007). Although the exact mechanisms by which probiotics provide health benefits in the intestine still remain unclear, the hypothesized mechanisms include i) competition for attachment sites, ii) competition for limiting nutrients, and iii) production of inhibitory metabolites (Nurmi et al., Intl. J. Food Microbiol. 15:237-240, 1992; Reid, Trends in Microbiology 14:348-352, 2006; Bogovic-Matijasic et al., Appl. Microbiol. Biotechnol. 49:606-612, 1998 and Lee et al., Appl. Environ. Microbiol. 66:3692-3697, 2000). The beneficial effects of probiotics include intestinal microflora modulation, competitive exclusion of pathogens, and immune stimulation (Collado et al., J. Food Prot. 69:1675-1679, 2006; and Servin and Coconnier, Best Practice & Research Clinical Gastroenterology 17:741-754, 2003). Probiotics of the present invention may comprise, in particular aspects, potentially any species of the genera Lactobacillus and Bifidobacterium. Non-limiting examples of such include: Lactobacillus paracasei, Lactobacillus acidophilus, Lactobacillus rhamnosus, Lactobacillus casei, Lactobacillus johnsonii, Lactobacillus lactis, Lactobacillus plantarum, Lactobacillus reuteri, Lactobacillus gasseri, Lactobacillus rhamnosus, Lactobacillus helveticus, Bifidobacterium longum Bifidobacterium animalis, Bifidobacterium bifidum, Bifidobacterium breve, Bifidobacterium infantis, and Bacillus coagulans.

The use of many commercial probiotics has been generally concerned with their beneficial effects in the GI tract. However, there still remains the important issue of how sufficient numbers of probiotic bacteria can realistically reach and bind to targeted sites (Zhao et al., J. Clinic. Microbiol. 36:641-647, 1998). In order for maximal health benefits to be achieved by a host, the number of probiotics that reach the colon is recommended to be around 10⁶ CFU/g (Shah, J. Dairy Sci. 83:894-907, 2000). The viability of probiotics delivered orally to a host will be decreased during passage through the acidic conditions of the simple stomach or fermentation of the ruminant stomach, resulting in less than the desired concentrations that actually reach and colonize in the GI tract. It has been found that microencapsulation significantly improved the viability of bifidobacteria in yogurt and frozen yogurt (Adhikari et al., J. Food Sci. 68:275-280, 2003 and Adhikari et al., J. Dairy Sci. 83:1946-1951, 2000), as well as in the presence of simulated gastric, bile, and pancreatic juices (Chang, Master of Science thesis. Columbia, Mo.: University of Missouri, 2002). The protection conferred to the probiotics by microencapsulation allows for higher numbers of probiotic bacteria to pass through the rumen and reach the lower intestinal tract of the animal, thus resulting in greater competitive exclusion effects.

### II. MICROENCAPSULATION

For instance, methods are provided for encapsulating or microencapsulating CE or probiotic microbes such that they are able to remain viable as they pass through the foregut and stomach, and reach the hindgut of ruminant animals. In the hindgut, they will inhibit pathogen growth and differentiation. In certain embodiments, microencapsulation involves the coating of a fine particle of an active core with an outer shell into small capsules (1 to 1000 pm). Encapsulation is a barrier method, preventing ingredients from reacting prematurely with their environment or degrading during processing or storage and can be applied to any scale manufacture. In the present invention, the encapsulation prevents the probiotic bacteria from being killed during the digestion process in the foregut (rumen, reticulum, omasum, abomasum, and small intestine). In one embodiment, microencapsulation is accomplished using a carrageenan matrix.

### III. RUMINANTS

In accordance with the invention, the microencapsulated probiotics can be delivered to a ruminant animal. A ruminant animal as used herein refers to any animal that digests food through a ruminant digestive system. The ruminant digestive system comprises a four compartment stomach, including the rumen, reticulum, omasum and abomasum. Food passing through the rumen and reticulum undergo digestion through microbial fermentation.

Although prior studies have investigated the use of microencapsulation to deliver probiotics, the focus of such research has been generally on use in animals with simple stomachs (monogastric), such as humans. The distinctive digestive properties of the ruminant stomach would render any such carrier material useful in a simple stomach generally unacceptable for use in a ruminant. In particular, digestion in the human stomach is based upon secretion of protein-digesting enzymes and strong acids. Ruminant digestion, however, includes digestive fermentation. In particular, instead of only using strong acids to digest ingested food, the ruminant stomach first breaks down food particles through fermentation facilitated by microbes present therein. Encapsulation materials designed to maintain the viability of probiotic bacteria through a simple stomach and into the lower intestine would not necessarily function to maintain viability of probiotic bacteria through a ruminant stomach. In particular, although carrageenan has been previously demonstrated to provide probiotic protection through the human stomach, one of skill in the art would expect such a material to be fermented in a ruminant stomach. One of skill in the art would therefore not have expected that carrageenan would have been capable of protecting probiotic bacteria in the foregut environment of a ruminant animal. The present invention, however, overcomes these difficulties in the art and provides supportive evidence of successful delivery of probiotic bacteria encapsulated by carrageenan to the hindgut for competitive exclusion of E. coli O157:H7.

### IV. ANIMAL FEED

The probiotics of the present invention can be provided to a ruminant animal as part of, with or on top of the animals daily feed. In one embodiment, the microencapsulated probiotic may be provided on top of the animal feed, for instance as a liquid poured over the feed provided to the animal. Alternatively, the probiotic may be mixed into the feed. The probiotic may be provided in or on the feed in the form of a liquid, for instance, suspended in a saline solution, or may be dried or lyophilized and added in or on the feed. In certain aspects, providing the probiotic with the animal's feed may present a method for controlling the amount of probiotic ingested by the animal.

Animal feed may comprise any suitable foodstuff for feeding to an animal. In certain embodiments, animal feed may comprise compound feed, such as food pellets, meal or crumbles; fodder/forage, such as hay, silage, crop residues, seeds, grains, fish meal or bone meal. Animal feed may be mostly of plant origin, but in some aspects, may be of animal origin. In one embodiment, animal feed may include any number of additives or supplements including vitamins, minerals, oils, antibiotics, and medicinal supplements.

### V. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Screening of Probiotics Against E. coli O157:H7 Strains

Multiple candidate bacteria were screened to identify the most efficacious against E. coli O157:H7.

A. Bacterial Strains and Culture Conditions

Five strains of E. coli O157:H7, MF1847, H2439, 3178-95, 43894, and C7927, were first tested by in vitro tests to determine suitability for use in the study. E. coli O157:H7 cells were cultivated in trypticase soy broth supplemented with 0.1% yeast extract (TSBY, Difco, BD Diagnostic Systems, Sparks, Md.) at 37° C. for 20 hours. Six different probiotic bacteria, Lactobacillus acidophilus ADH, Lactobacillus paracasei ATCC 25598, Lactobacillus rhamnosus GG, Bifidobacterium animalis BB-12, Bifidobacterium bifidum A, and Bifidobacterium animalis subsp. lactis Bif-6 (previously referred to as Bifidobacterium longum B6) were tested to determine antagonistic effects against E. coli O157:H7. Probiotics were cultivated in de Man, Rogosa, Sharpe (MRS, Difco) broth at 37° C. for 24 hours. All cultures used are part of the culture collection of the Food Microbiology Laboratory, University of Missouri-Columbia.

B. Well Diffusion Assay

Twenty milliliters of trypticase soy agar (TSA, Difco) containing 10⁷ CFU/ml of E. coli O157:H7 cells were poured into a Petri dish. Wells (dia. 5 mm each) were aseptically made in the agar using a sterile cork borer and filled with 100 μl of each probiotic (broth culture and cell-free supernatant). The plates were incubated at 37° C. for 24-48 hours and observed for clear inhibition zones. The larger the clear zones around each well, the greater the inhibition by the specific probiotic bacterium tested.

C. Agar Spot Test

Each probiotic bacterium (10⁶ CFU/ml) was plated on MRS agar and incubated anaerobically at 37° C. for 48 hours. The E. coli O157:H7 indicator bacterium (10⁶-10⁷ CFU/ml) were mixed with 12 ml of semi-solid agar and poured over the solidified MRS agar plate containing visible probiotic colonies. The plates were incubated at 37° C. for 24-48 hours and observed for growth or inhibition. Negative indicated no growth on plates after incubation.

Results of the well diffusion and agar spot assays are shown in Tables 1 and 2. Lactobacillus paracasei and Bifidobacterium animalis Bif-6, were selected based on results of the in vitro assays.

TABLE 1
Well diffusion assay (inhibition zones in mm).

| | Probiotic | | | | | |
|---|---|---|---|---|---|---|
| E. coli | L. acidophilus | | L. rhamnosus | B. animalis | | B. animalis |
| O157:H7 | ADH | L. paracasei | GG | BB-12 | B. bifidum | Bif-6 |
| MF1847 | 12.2 | 12.8 | 13.3 | 11.1 | 11.8 | 11.9 |
| H2439 | 11.2 | 13.9 | 11.7 | 10.8 | 11.9 | 12.1 |
| 3178-95 | 12.2 | 12.0 | 11.8 | 11.7 | 10.4 | 10.9 |
| 43894 | 11.0 | 11.2 | 13.6 | 10.3 | 10.2 | 12.1 |
| C7927 | 10.8 | 12.9 | 13.5 | 9.6 | 10.7 | 10.8 |
| Average | 11.48 | 12.56 | 12.78 | 10.7 | 11.0 | 11.56 |
| zone dia. | | | | | | |

TABLE 2
Agar spot assay

| | Probiotic | | | | | |
|---|---|---|---|---|---|---|
| E. coli | L. acidophilus | | L. rhamnosus | B. animalis | | B. animalis |
| O157:H7 | ADH | L. paracasei | GG | BB-12 | B. bifidum | Bif-6 |
| MF1847 | + | − | − | + | + | − |
| H2439 | − | − | − | − | − | − |
| 3178-95 | − | − | − | + | − | − |
| 43894 | − | − | − | + | − | − |
| C7927 | − | − | − | + | − | − |

### Example 2

### Selection of Microencapsulation Material

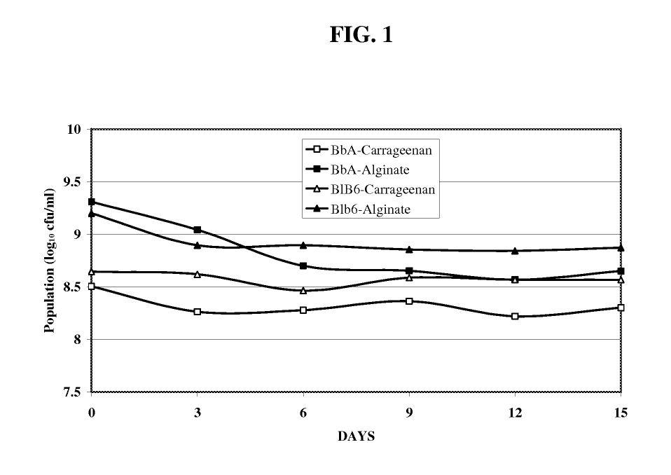

Initially, various concentrations of agar, gelatin, guar gum, alginate and carrageenan were screened for suitability as microencapsulation material. After several trials, agar was deemed unsuitable because of its high viscosity and difficulty of manipulation, while guar gum and gelatin did not form capsules. These materials were discarded from further studies. Preliminary studies were then conducted with κ-carrageenan and calcium alginate as possible microencapsulation materials for two strains of probiotics, Bifidobacterium bifidum A and Bifidobacterium animalis Bif-6. Freshly grown bifidobacterial cells were centrifuged at 6000×g for 10 minutes and washed with sterile saline twice. The cell pellets were resuspended in 2 ml of sterile saline for encapsulation. Microencapsulation polymers were made using (1) 2.5% κ-carrageenan in 0.9% NaCl solution, and (2) 3.5% calcium alginate (medium viscosity) in sterile distilled water. Polymer solutions were heated at 100° C. for 5 minutes. The polymer solutions were tempered to around 40° C. and the cell suspensions were added to 10 ml of each polymer solution. Mixtures were vortexed thoroughly to mix and the polymer/cell mixture was added to 50 ml of vegetable oil (Crisco) containing 0.2% Tween 80. The mixtures were stirred by magnetic stirring for approximately 15 minutes to allow a uniform emulsion to form. The emulsion was broken by adding 0.3 M KCl for x-carrageenan and 0.05 M CaCl₂ for Ca-alginate treatment, respectively. The oil phase was decanted and the beads (microcapsules) were recovered by centrifugation and washing with sterile distilled water twice at 350×g. The beads were stored in sterile distilled water before use. To determine the survival of the encapsulated bacteria in each polymer material, beads were added to sterile skim milk and stored at 4° C. for up to 15 days. On days 0, 3, 6, 9, 12 and 15, an aliquot was taken out of each treatment for enumeration of bifidobacterial cells. For solubilization of the capsular material in order to release the encapsulated cells for enumeration, 1 ml of the x-carrageenan treatment was transferred to 9 ml of 0.1 M phosphate buffer +0.05 M EDTA, while 1 ml of the alginate treatment was transferred to 9 ml of 0.1 M phosphate buffer+0.025 M EDTA. These tubes were incubated at 45° C. for 20 minutes in a temperature-controlled water bath before subsequent dilutions were done in sterile peptone water for plating in MRS agar supplemented with 0.05% cysteine-HCL. FIG. 1 shows a comparison of the two bifidobacterial strain survival in carrageenan and alginate capsules over 15 days. Carrageenan capsules resulted in a lower reduction in cell numbers over time than alginate capsules for both strains tested.

### Example 3

### Preparation of Microencapsulated Probiotic Cultures

Probiotic cells were encapsulated by the method of Sheu and Marshall (J. Food Sci. 54:557-561, 1993) with slight modification (Adhikari et al., J. Food Sci. 68:275-280, 2003 and Adhikari et al., J. Dairy Sci. 83:1946-1951, 2000). Cultured cells (250 ml) were harvested by centrifugation at 4,000×g for 15 minutes, washed twice at the same centrifugation condition, and resuspended in sterile saline solution. The final cell concentration was adjusted to approximately 5.0×10⁹ CFU/ml by estimating the optical density at 600 nm. The cell suspension (40 ml) was mixed with 120 ml of 2% κ-carrageenan (Research Product International Co., Mt. Prospect, Ill.), containing 0.9% NaCl which improved the dispersability of κ-carrageenan, in a water bath at 47 to 48° C. Vegetable oil (Crisco, Cincinnati, Ohio) was stirred with 0.1% Tween 80 (Fisher Scientific, Pittsburgh, Pa.) as an emulsifier at 40° C. for 2 minutes. The mixture (cell+κ-carrageenan) was quickly added into 200 ml of vegetable oil and stirred at 250 rpm for 10 minutes. After emulsification and encapsulation, 300 ml of 0.3 M KCl was quickly added to stabilize the capsules. The oil phase was aspirated and the capsules were harvested by gentle centrifugation at 350×g for 10 min.

### Example 4

### Inoculation of Cattle with E. coli O157:H7 and Probiotic Treatment

Pure cultures of the probiotic bacteria, Lactobacillus paracasei and Bifidobacterium animalis ssp. lactis Bif-6, selected based on antagonistic in vitro assays described in Example 1, were obtained from the Food Microbiology Laboratory, Food Science Program, University of Missouri Culture Collection. Probiotic cells were anaerobically cultivated in de Man, Rogosa and Sharpe (MRS, Difco, Detroit, Mich.) broth supplemented with 0.05% cysteine-HCl at 37° C. for 24 hours. Nalidixic acid resistant (NaI^{r}) strains of E. coli O157:H7 were obtained for use in the cattle feeding study in order to facilitate enumeration of cells used as the inocula. To screen a highly NaI^{r} strain, strains of E. coli O157:H7 were serially cultivated in trypticase soy broth (TSB) and plated on MacConkey-sorbitol agar containing 0.1, 0.2, 0.4, 0.8, 1.6, 3.2, 6.4, 12.8, 25, or 50 μg/ml of nalidixic acid (Fisher Scientific, Fair Lawn, N.J.) at 37° C. for 18 hours (Zhao et al., J. Clinic. Microbiol. 36:641-647, 1998). Cultures were centrifuged at 4,000×g for 15 minutes and washed twice in peptone water prior to use. The strain showing the greatest resistance and stability to nalidixic acid was chosen for the cattle study.

Forty-five 2-year old Angus cross-bred steers (average initial weight of 480±33 kg) and heifers (average initial weight of 548±45 kg) were individually tagged with a unique number and confirmed to be free of detectable E. coli O157:H7. Cattle were fed once per day in the morning and had access to water ad libitum. The basal diet consisted of corn (74.3% DM), soybean hull (15.0% DM), soybean meal (7.95% DM), casein (5.5% DM), KCl (0.25% DM), and trace mineral salts (0.9% DM). Steers and heifers were housed in separate blocks and allotted into eight pens with four to seven steers (or heifers) per pen. The pens were randomly assigned within blocks to one of four treatments.

The highly stable NaI^{r} E. coli O157:H7 was selected and confirmed that the survival and growth characteristics were similar when compared to its wild-type strain. Each animal was perorally inoculated with 10 ml of NaI^{r} E. coli O157:H7 (10⁹ CFU/ml) mixed with 40 ml of skim milk administered by syringe. Cattle inoculated with NaI^{r} E. coli O157:H7 remained clinically normal with no evidence of diarrhea or blood with the exception of two animals.

After 2 days of NaI^{r} E. coli O157:H7 challenge, the cattle were fed probiotic treatments including the control, non-encapsulated probiotics (L. paracasei+B. animalis B6), microencapsulated probiotics (L. paracasei+B. animalis ssp. lactis Bif-6), or commercial probiotic (NPC 747, Nutrition Physiology Co., Indianapolis, Ind.) for 42 days consecutively. The treatments were directly spread on the top of the daily feed at approximately 10¹⁰ CFU.

Cattle inoculated with 10¹⁰ CFU of NaI^{r} E. coli O157:H7 maintained clinically normal and good appetite with no evidence of diarrhea or blood throughout the experiment except that cattle (S0066) had diarrhea with blood at 14 days p.i. and cattle (H2285 and S2390) had mild diarrhea at 44 days p.i. The populations of total aerobic and anaerobic bacteria in feces from all cattle ranged from 6.76 to 8.43 and from 6.87 to 8.65 log CFU/g, respectively (Table 3). Total aerobic and total anaerobic bacterial numbers were not significantly different among all treatments over time. No particular increasing or decreasing trend was observed in total aerobic and anaerobic bacterial counts for all treatments. Treatments did not affect total aerobic and anaerobic bacterial groups in cattle feces. The average initial cattle weights were 527.49, 523.69, 517.55, and 509.92 kg for the control, NPC 747, non-encapsulation, and microencapsulation, respectively (Table 3). The cattle weights gradually increased to between 550.25 and 563.20 kg at 44 days p.i. Although cattle treated with NPC 747 had a numerically higher body weight compared to cattle from the other treatments, no significant difference in cattle weights were observed among all treatments during the 44 days.

TABLE 3
Total aerobic and anaerobic bacteria (mean ± SD^{a} log CFU/g)
in cattle feces and body weight (mean ± SD kg)

| Treatment | | | |
|---|---|---|---|
| Control | NPC 747 | NME^{b} | MEC^{c} |

Total aerobic bacteria

| | | | | |
|---|---|---|---|---|
| 0 days p.i. | 7.89 ± 0.42 | 7.79 ± 0.15 | 7.71 ± 0.24 | 7.59 ± 0.27 |
| 2 days p.i. | 7.18 ± 0.54 | 7.48 ± 0.45 | 7.44 ± 0.67 | 6.76 ± 0.37 |
| 9 days p.i. | 8.29 ± 0.87 | 8.37 ± 0.81 | 8.18 ± 0.62 | 8.30 ± 0.78 |
| 16 days p.i. | 7.90 ± 0.84 | 8.05 ± 0.69 | 8.43 ± 0.76 | 8.05 ± 0.86 |
| 30 days p.i. | 7.50 ± 0.46 | 7.41 ± 0.46 | 7.30 ± 0.28 | 7.38 ± 0.34 |
| 44 days p.i. | 7.66 ± 0.47 | 7.62 ± 0.43 | 7.56 ± 0.29 | 7.67 ± 0.37 |

Total anaerobic bacteria

| | | | | |
|---|---|---|---|---|
| 0 days p.i. | 7.81 ± 0.46 | 7.78 ± 0.37 | 7.75 ± 0.48 | 7.28 ± 0.42 |
| 2 days p.i. | 7.14 ± 0.51 | 7.31 ± 0.65 | 7.34 ± 0.71 | 6.87 ± 0.42 |
| 9 days p.i. | 8.65 ± 0.87 | 7.98 ± 0.32 | 8.47 ± 0.83 | 8.09 ± 0.94 |
| 16 days p.i. | 7.69 ± 0.49 | 8.04 ± 0.68 | 7.98 ± 0.81 | 7.98 ± 0.64 |
| 30 days p.i. | 6.98 ± 0.32 | 7.06 ± 0.62 | 7.28 ± 0.41 | 6.87 ± 0.55 |
| 44 days p.i. | 7.61 ± 0.47 | 7.34 ± 0.40 | 7.46 ± 0.54 | 7.67 ± 0.45 |

Body weight

| | | | | |
|---|---|---|---|---|
| 0 days p.i. | 527.49 ± 48.41 | 523.69 ± 48.56 | 517.55 ± 55.71 | 509.92 ± 60.96 |
| 2 days p.i. | 511.90 ± 45.76 | 518.91 ± 43.21 | 514.00 ± 55.35 | 499.45 ± 60.94 |
| 9 days p.i. | 525.42 ± 44.01 | 534.29 ± 44.72 | 518.99 ± 56.19 | 515.53 ± 65.37 |
| 16 days p.i. | 529.96 ± 44.22 | 539.45 ± 45.93 | 526.70 ± 56.83 | 522.37 ± 65.00 |
| 30 days p.i. | 534.58 ± 37.27 | 547.20 ± 47.32 | 535.09 ± 56.99 | 529.05 ± 74.99 |
| 44 days p.i. | 561.96 ± 54.00 | 563.20 ± 46.56 | 558.98 ± 62.95 | 550.25 ± 75.30 |

^{a}SD is standard deviation.
^{b}NME is non-microencapsulation.
^{c}MEC is microencapsulation.

### Example 5

### Effects of Probiotics on Fecal Shedding of E. coli O157:H7

A. Fecal Sampling

Fecal grab samples were collected from each of the animals from Example 2 on day 0, 2, 9, 16, 30, and 44 postinoculation (p.i.) immediately after each animal was weighed. Upon collection, fecal samples were placed in 20 ml of Cary-Blair medium and transported on ice to the Food Microbiology laboratory within 2 hours. Total aerobic and total anaerobic bacteria were enumerated by plating on tryptic soy agar (TSA; Difco, Detroit, Mich.) and TSA supplemented with 5% defibrinated sheep blood, respectively, at 37° C. for 48 to 72 hours (Table 3).

B. Isolation and Enumeration of E. coli O157:H7

Direct plating and selective enrichment methods used to isolate E. coli O157:H7 from fecal samples were proceeded as follows; 1) fecal samples (2 g) were serially diluted (1:10) with 0.1% peptone water, and 0.1 ml of each dilution was plated in duplicate on MacConkey Sorbitol Agar containing 50 μg/m1 nalidixic acid (MSA^{NaI}) (sensitivity ≧10² CFU/g); 2) fecal samples (0.1 g) were plated in duplicate on MSA^{NaI} (sensitivity ≧10 CFU/g); and 3) fecal samples (1.0 g) were incubated in TSB (10 ml) containing 50 μg/ml nalidixic acid at 37° C. for 24 hours, followed by plating on MSA^{NaI} , incubating at 37° C. for 24 hours and suspect colonies confirmed by RIM® E. coli O157:H7 Latex Test (REMEL, Lenexa, Kans.).

C. Statistical Analysis

The experiment was designed as a randomized complete block design with repeated measures over time for each pen as the experimental unit. The magnitude of fecal shedding was analyzed using the GLM repeated measures procedures of SAS (SAS Inst. Inc., Cary, N.C.). The model included the effects of treatment, time, and interaction between treatment and time. The viability of E. coli O157:H7 below the detection limit was observed by enrichment culture, and negative or positive growth was assigned at 0.9 and 0 log CFU/ml, respectively, for statistical analysis. Data from cattle (H2290) treated with non-encapsulated probiotics were removed as an outlier that excessively lowered the number of E. coli O157:H7 at 2 days p.i. (Table 4).

D. Results

Most untreated and probiotic-treated cattle shed high numbers (initial fecal shedding >4.5 log CFU/g) of challenge NaI^{r} E. coli O157:H7 ranging from 7.1×10² to 1.2×10⁶ CFU/g at 2 days p.i. and detectable numbers (>3.0 log CFU/g) of NaI^{r} E. coli O157:H7 by 16 days p.i. (Table 4). No significant differences in fecal shedding of E. coli O157:H7 was observed among treatments during 9 days p.i. The numbers of fecal shedding were decreased for all treatments throughout the period of 44 days. Although most cattle showed a similar pattern of decrease in the number of E. coli O157:H7, cattle treated with microencapsulated probiotics more significantly decreased fecal shedding of the pathogen in a feeding trial over 42 days. The control, NPC 747, and non-microencapsulated probiotic-treated cattle still shed higher numbers (>2.0 log CFU/g) of E. coli O157:H7 at 30 days p.i. when compared to microencapsulated probiotic-treated cattle. The fecal populations of E. coli O157:H7 in cattle treated with microencapsulated probiotics were significantly lower than those of the other treatments at 30 and 44 days p.i. (p<0.05). At day 44 p.i., most cattle treated with microencapsulated probiotics shed less than a detectable level (<1.0 log CFU/g), which was only culture positive by enrichment (0.42 log CFU/g). The average numbers of E. coli O157:H7 shed were decreased to 1.18, 1.32, and 2.07 log CFU/g for control, NPC 747, non-encapsulation, respectively. Cattle fed microencapsulated probiotics had a shorter duration of E. coli O157 carriage when compared to the other treatments. The numbers of fecal shedding of E. coli O157:H7 in steers were numerically lower than those in heifers for all treatments except for the cattle group fed microencapsulated probiotics where heifers were lower than steers in fecal shedding on days 30 and 44 p.i. However, the numbers of fecal shedding of E. coli O157:H7 in heifers were not significantly different from those in steers for all treatments (p>0.05).

Total aerobic and total anaerobic bacteria were stable and present at consistent levels in feces throughout the 42 days p.i. regardless of treatments (Table 3). This suggests that the probiotics fed were incorporated into the total microflora without interfering with background microflora or changing the proportions of resident aerobic and anaerobic bacteria.

The probiotics used in this example were the same as those used as industry standards (BOVAMINE™ and others), which are not encapsulated. These results demonstrate that microencapsulation of the probiotic bacteria using carrageenan generated significantly improved results in decreasing fecal shedding of the pathogen as compared to the industry standard.

In the present example, the number and duration of E. coli O157:H7 varied widely among individual cattle within treatment following an oral challenge (Table 4). There was a shedding pattern towards lower levels of E. coli O157:H7 until near the end of the feeding period. However, cattle from the control (H2266 and S2385), NPC 747 (H2375 and 52360) and non-encapsulation (H2362 and 52329) treatments showed a long-term persistence during the study (Table 4). This observation implies that E. coli O157:H7 possibly colonized and periodically replicated in the GI tract of these animals. The use of encapsulated probiotics may contribute to the homeostasis of the microbial flora associated with competitive exclusion in the rumen and intestines.

The presence and quantification of different groups of bacteria were assayed in addition to enumeration of aerobic and anaerobic bacteria (Table 3) and E. coli O157:H7 (Table 4) described above. In particular, data was collected for the enumeration of total lactic acid bacteria plated in MRS agar (Table 5), lactobacilli plated in MRS agar supplemented with vancomycin (Table 6), and bifidobacteria plated in Raffinose Columbia Blood Agar NP (Table 7).

Probiotics have been well known to possess inhibitory activity against pathogenic bacteria, including reducing E. coli O157:H7 carriage and colonization in cattle (Zhao et al., J. Clinic. Microbiol. 36:641-647, 1998 and Zhao et al., J. Food Prot. 66:924-930, 2003). In this example, the fact that NPC 747 and non-encapsulated probiotics did not effectively reduce the fecal shedding of E. coli O157:H7 suggests that an insufficient number of probiotics reached the colon through these feeding trials. The fecal shedding of E. coli O157:H7 considerably decreased in cattle fed microencapsulated probiotics to the point of being enrichment negative. Microencapsulation may therefore increase the survival of the probiotic bacteria that effectively reduced the number and duration of fecal shedding of E. coli O157:H7.

TABLE 4
Fecal shedding in cattle infected with E. coli
O157:H7 at four different treatments

| | E. coli O157:H7 (log CFU/g) | | | | |
|---|---|---|---|---|---|
| Treatment | 2 days | 9 days | 16 days | 30 days | 44 days |
| Cattle | p.i. | p.i. | p.i. | p.i. | p.i. |
| Control | | | | | |
| H2266 | 5.44 | 3.95 | 3.34 | 4.21 | 2.95 |
| H2292 | 3.30 | 2.00 | +^{a} | + | −^{b} |
| H2312 | 3.78 | 3.30 | 3.90 | 2.78 | − |
| H2359 | 3.90 | 4.81 | 4.71 | 3.18 | + |
| S0107 | 3.85 | 3.00 | 2.48 | − | − |
| S2254 | 4.85 | 3.00 | 3.72 | 2.30 | + |
| S2258 | 5.30 | + | − | − | − |
| S2271 | 4.90 | 3.70 | 2.18 | 3.43 | 3.23 |
| S2277 | 4.10 | 3.78 | 2.30 | 2.65 | + |
| S2350 | 5.30 | 4.65 | 3.22 | 3.90 | 3.20 |
| S2385 | 5.95 | 3.30 | 2.98 | 1.90 | + |
| NPC 747 | | | | | |
| H2261 | 3.74 | 4.75 | 3.82 | 1.18 | + |
| H2285 | 5.95 | 3.48 | 3.76 | 3.06 | 1.95 |
| H2296 | 4.39 | 2.00 | + | 1.90 | + |
| H2336 | 3.60 | 3.48 | 3.47 | 2.98 | + |
| H2375 | 4.42 | 3.70 | 3.56 | 3.76 | 4.17 |
| S0066 | 4.41 | + | + | − | − |
| S0075 | 3.18 | 3.00 | 2.18 | + | − |
| S2327 | 5.30 | 2.00 | + | 2.15 | 2.48 |
| S2351 | 6.08 | 3.60 | 3.10 | 3.34 | + |
| S2360 | 4.30 | 5.30 | 3.84 | 3.60 | 2.30 |
| S2367 | 5.48 | + | − | − | − |
| NME^{c} | | | | | |
| H2290 | + | + | + | + | − |
| H2307 | 3.48 | 4.26 | 4.46 | 4.20 | 4.54 |
| H2347 | 5.13 | 3.90 | 3.61 | 4.01 | 2.90 |
| H2362 | 3.95 | 5.31 | 4.93 | 4.20 | 4.36 |
| H2379 | 4.03 | 3.00 | 2.70 | 3.53 | − |
| S2273 | 5.48 | 4.34 | 2.70 | 1.18 | − |
| S2276 | 5.30 | 4.30 | 3.60 | 1.95 | 3.43 |
| S2304 | 5.07 | + | + | + | − |
| S2317 | 5.30 | 3.95 | 2.18 | 2.50 | 2.00 |
| S2329 | 5.30 | 5.36 | 3.75 | 4.75 | 4.67 |
| S2356 | 4.70 | 3.00 | 2.78 | 3.93 | + |
| S2393 | 3.92 | + | + | | |
| MEC^{d} | | | | *^{e} | * |
| H2250 | 5.05 | 3.70 | 1.51 | − | − |
| H2297 | 4.18 | 2.30 | 2.30 | − | − |
| H2366 | 2.85 | 4.97 | 2.30 | + | + |
| H2380 | 5.30 | 5.23 | 2.18 | + | − |
| H2381 | 5.27 | 3.78 | + | − | − |
| S2264 | 5.48 | 3.30 | + | + | − |
| S2313 | 4.50 | 4.00 | 2.70 | 2.54 | − |
| S2324 | 4.07 | 4.79 | 2.95 | 2.60 | 2.85 |
| S2345 | 3.48 | 3.70 | 1.93 | + | + |
| S2363 | 4.30 | 3.30 | 1.81 | − | − |
| S2390 | 5.48 | 2.00 | 2.18 | 1.78 | − |

^{a}Positive indicates the growth by enrichment but not detected by direct plating at 1.0 log CFU/g.
^{b}Negative indicates no growth by enrichment culture.
^{c}NEC stands for non-encapsulation.
^{d}MEC stands for microencapsulation.
^{e}* indicates the significant difference within a column among treatments (p < 0.05).

TABLE 5
Enumeration of total lactic acid bacteria, plated on MRS agar

| | Sex | TRT | 0 d | 2 d | 9 d | 16 d | 30 d | 44 d | 44 d average. |
|---|---|---|---|---|---|---|---|---|---|
| 1 | Heifer | Control | * | * | 7.61 | 7.18 | 7.26 | 7.62 | |
| 2 | Heifer | Control | 6.30 | * | 7.06 | 7.11 | 8.07 | 7.71 | |
| 3 | Heifer | Control | * | * | 7.00 | 6.78 | 7.08 | 8.21 | |
| 4 | Heifer | Control | * | 6.65 | 7.28 | 6.85 | 7.11 | 6.85 | |
| 5 | Steer | Control | 8.09 | * | 7.61 | 8.26 | 7.74 | 7.46 | |
| 6 | Steer | Control | * | * | 7.41 | 8.52 | 7.04 | 7.60 | |
| 7 | Steer | Control | 7.49 | 6.94 | 7.26 | 7.62 | 7.61 | 7.20 | |
| 8 | Steer | Control | 8.33 | * | 7.30 | 7.71 | 7.46 | 7.51 | |
| 9 | Steer | Control | 7.90 | 6.81 | 8.78 | 7.30 | 7.30 | 7.20 | |
| 10 | Steer | Control | 7.78 | 6.60 | 7.62 | 7.64 | 7.32 | 7.04 | |
| 11 | Steer | Control | 8.21 | | 7.56 | 7.15 | 7.46 | 7.18 | 7.416918 |
| 12 | Heifer | Bovamine | * | * | 6.81 | 6.78 | 7.60 | 7.43 | |
| 13 | Heifer | Bovamine | * | * | 7.79 | 6.90 | 7.08 | 6.48 | |
| 14 | Heifer | Bovamine | * | * | 7.75 | 7.32 | 7.72 | 7.11 | |
| 15 | Heifer | Bovamine | * | * | 7.79 | 7.30 | 7.97 | 7.18 | |
| 16 | Heifer | Bovamine | 7.14 | * | 6.88 | 7.34 | 7.76 | 7.45 | |
| 17 | Steer | Bovamine | * | 7.18 | 7.43 | 7.76 | 7.66 | 7.91 | |
| 18 | Steer | Bovamine | 6.30 | 7.01 | 7.70 | 7.43 | 7.60 | 8.06 | |
| 19 | Steer | Bovamine | 6.00 | * | 7.62 | 6.78 | 7.54 | 7.28 | |
| 20 | Steer | Bovamine | 6.30 | 7.23 | 7.53 | 6.60 | 7.30 | 7.08 | |
| 21 | Steer | Bovamine | * | * | 7.63 | 7.18 | 7.69 | 7.04 | |
| 22 | Steer | Bovamine | 6.30 | * | 8.13 | 7.11 | 7.54 | 7.32 | 7.30331 |
| 23 | Heifer | Non-cap | * | * | 6.98 | 7.20 | 7.43 | 7.43 | |
| 24 | Heifer | Non-cap | * | * | 7.66 | 7.62 | 7.57 | 7.72 | |
| 25 | Heifer | Non-cap | * | * | 7.36 | 6.95 | 7.98 | 7.66 | |
| 26 | Heifer | Non-cap | * | * | 7.41 | 7.41 | 7.45 | 6.78 | |
| 27 | Heifer | Non-cap | * | * | 6.48 | 7.15 | 7.00 | 7.57 | |
| 28 | Steer | Non-cap | 7.30 | * | 7.53 | 6.90 | 7.57 | 7.34 | |
| 29 | Steer | Non-cap | * | * | 8.12 | 8.18 | 6.78 | 6.95 | |
| 30 | Steer | Non-cap | 8.30 | * | 7.77 | 7.41 | 7.52 | 7.28 | |
| 31 | Steer | Non-cap | 7.83 | * | 7.76 | 6.30 | 7.38 | 7.23 | |
| 32 | Steer | Non-cap | 7.60 | 6.88 | 7.53 | 6.70 | 6.85 | 7.53 | |
| 33 | Steer | Non-cap | * | * | 7.45 | 7.41 | 7.00 | 7.85 | |
| 34 | Steer | Non-cap | * | * | 7.32 | 7.11 | 7.20 | 7.15 | 7.374268 |
| 35 | Heifer | Microcap | * | * | 7.59 | 7.23 | 7.32 | 7.58 | |
| 36 | Heifer | Microcap | * | * | 7.42 | 6.78 | 7.18 | 7.30 | |
| 37 | Heifer | Microcap | * | * | 7.72 | 7.08 | 7.59 | 7.73 | |
| 38 | Heifer | Microcap | * | * | 7.29 | 7.36 | 7.73 | 7.49 | |
| 39 | Heifer | Microcap | * | * | 7.75 | 7.59 | 7.68 | 7.08 | |
| 40 | Steer | Microcap | 7.73 | * | 6.95 | 7.38 | 6.78 | 7.41 | |
| 41 | Steer | Microcap | 7.95 | * | 7.08 | 8.63 | 7.40 | 7.36 | |
| 42 | Steer | Microcap | 7.43 | * | 7.79 | 7.15 | 7.59 | 7.70 | |
| 43 | Steer | Microcap | 7.32 | * | 7.00 | 6.85 | 7.04 | 7.36 | |
| 44 | Steer | Microcap | 7.71 | * | 7.08 | 7.41 | 7.63 | 7.38 | |
| 45 | Steer | Microcap | 7.76 | * | 7.76 | 7.59 | 7.52 | 8.19 | 7.50808 |

TABLE 6
Enumeration of lactobacilli plated in MRS agar supplemented with vancomycin

| Pen | Sex | TRT | 0 d | 2 d | 9 d | 16 d | 30 d | 44 d | 44 d average. |
|---|---|---|---|---|---|---|---|---|---|
| 1 | Heifer | Control | 7.10 | 7.15 | 7.33 | 6.60 | 6.85 | 6.00 | |
| 2 | Heifer | Control | 6.51 | 6.78 | 6.54 | 6.30 | 7.15 | 7.15 | |
| 3 | Heifer | Control | 6.95 | 6.95 | 6.48 | 6.60 | 6.48 | 6.78 | |
| 4 | Heifer | Control | 7.04 | 6.95 | 6.40 | 6.00 | 6.95 | 6.70 | |
| 5 | Steer | Control | 7.04 | 7.11 | 6.98 | 6.70 | 7.41 | 6.48 | |
| 6 | Steer | Control | 6.90 | 7.60 | 6.54 | 6.30 | 6.28 | 7.38 | |
| 7 | Steer | Control | 7.08 | 7.11 | 7.02 | 6.95 | 7.15 | 6.78 | |
| 8 | Steer | Control | 7.38 | 6.60 | 6.81 | 6.78 | 6.60 | 7.15 | |
| 9 | Steer | Control | 7.30 | 6.75 | 7.47 | 7.18 | 7.08 | 6.30 | |
| 10 | Steer | Control | 6.90 | 5.90 | 6.85 | 6.30 | 6.48 | 5.74 | |
| 11 | Steer | Control | 6.85 | 7.51 | 7.27 | 7.00 | 6.78 | 6.30 | 6.613389 |
| 1 | Heifer | Bovamine | 7.30 | 7.41 | 6.48 | 6.30 | 7.40 | 6.70 | |
| 2 | Heifer | Bovamine | 6.78 | 6.78 | 6.90 | 6.78 | 6.90 | 5.78 | |
| 3 | Heifer | Bovamine | 6.08 | 6.00 | 7.37 | 6.95 | 7.18 | 6.48 | |
| 4 | Heifer | Bovamine | 7.20 | 7.04 | 7.41 | 7.04 | 7.38 | 6.95 | |
| 5 | Heifer | Bovamine | 7.11 | 7.48 | 7.04 | 6.90 | 7.71 | 6.90 | |
| 6 | Steer | Bovamine | 7.11 | 7.11 | 7.02 | 6.48 | 7.18 | 7.23 | |
| 7 | Steer | Bovamine | 6.78 | 7.11 | 6.85 | 6.70 | 7.18 | 6.85 | |
| 8 | Steer | Bovamine | 7.06 | 7.10 | 6.54 | 6.30 | 6.30 | 7.08 | |
| 9 | Steer | Bovamine | 7.10 | 7.26 | 7.00 | 6.70 | 7.08 | 7.11 | |
| 10 | Steer | Bovamine | 7.26 | 7.20 | 7.40 | 6.70 | 7.28 | 5.65 | |
| 11 | Steer | Bovamine | 7.34 | 7.51 | 7.06 | 6.30 | 7.26 | 6.70 | 6.675675 |
| 1 | Heifer | Non-cap | 6.48 | 6.60 | 6.48 | 6.60 | 6.60 | 7.08 | |
| 2 | Heifer | Non-cap | 7.72 | 7.56 | 7.36 | 6.85 | 6.90 | 7.40 | |
| 3 | Heifer | Non-cap | 7.18 | 7.34 | 6.95 | 6.30 | 7.67 | 7.32 | |
| 4 | Heifer | Non-cap | 7.53 | 8.08 | 6.95 | 7.08 | 6.90 | 5.70 | |
| 5 | Heifer | Non-cap | 7.29 | 7.38 | 6.60 | 6.30 | 6.90 | 7.00 | |
| 6 | Steer | Non-cap | 6.98 | 7.20 | 6.88 | 6.30 | 6.78 | 7.08 | |
| 7 | Steer | Non-cap | 7.08 | 6.60 | 7.32 | 6.70 | 6.85 | 6.48 | |
| 8 | Steer | Non-cap | 7.32 | 7.13 | 6.78 | 7.00 | 6.78 | 6.60 | |
| 9 | Steer | Non-cap | 6.85 | 7.06 | 6.98 | 6.60 | 7.18 | 7.23 | |
| 10 | Steer | Non-cap | 7.28 | 7.70 | 6.88 | 5.70 | 6.85 | 6.85 | |
| 11 | Steer | Non-cap | 6.90 | 6.81 | 6.60 | 6.70 | 6.48 | 7.28 | |
| 12 | Steer | Non-cap | 7.20 | 7.64 | 6.93 | 6.60 | 7.00 | 6.78 | 6.899094 |
| 1 | Heifer | Microcap | 6.70 | 6.60 | 7.29 | 7.00 | 6.95 | 6.95 | |
| 2 | Heifer | Microcap | 6.18 | 6.48 | 7.02 | 6.15 | 6.48 | 6.00 | |
| 3 | Heifer | Microcap | 6.54 | 6.78 | 6.90 | 6.85 | 7.04 | 7.34 | |
| 4 | Heifer | Microcap | 6.04 | 6.00 | 7.22 | 6.90 | 7.28 | 7.26 | |
| 5 | Heifer | Microcap | 6.48 | 6.95 | 7.28 | 6.70 | 7.41 | 6.00 | |
| 6 | Steer | Microcap | 6.95 | 7.32 | 6.30 | 6.30 | 6.30 | 6.48 | |
| 7 | Steer | Microcap | 7.30 | 7.30 | 6.78 | 6.95 | 6.78 | 6.60 | |
| 8 | Steer | Microcap | 6.95 | 6.60 | 7.10 | 6.60 | 7.08 | 6.70 | |
| 9 | Steer | Microcap | 6.48 | 6.48 | 6.48 | 6.30 | 6.90 | 6.95 | |
| 10 | Steer | Microcap | 6.48 | 7.26 | 6.54 | 6.85 | 7.18 | 7.00 | |
| 11 | Steer | Microcap | 7.28 | 6.85 | 7.30 | 8.33 | 7.30 | 7.23 | 6.774071 |

TABLE 7
Enumeration of bifidobacteria plated in Raffinose Columbia Blood Agar NP

| | | | | | | | | | | 44 d |
|---|---|---|---|---|---|---|---|---|---|---|
| | Pen | Sex | TRT | 0 d | 2 d | 9 d | 16 d | 30 d | 44 d | average. |
| 1 | 1 | Heifer | Control | 6.41 | 7.09 | 7.43 | 6.92 | 6.30 | 7.38 | |
| 2 | 2 | Heifer | Control | 5.83 | 6.58 | 6.90 | 6.62 | 8.10 | 7.69 | |
| 3 | 3 | Heifer | Control | 6.00 | 5.90 | 6.85 | 7.41 | 6.95 | 7.18 | |
| 4 | 4 | Heifer | Control | 6.00 | 6.23 | 6.78 | 6.72 | 7.04 | 7.11 | |
| 5 | 5 | Steer | Control | 6.34 | 6.59 | 7.15 | 7.43 | 7.69 | 7.18 | |
| 6 | 6 | Steer | Control | 6.49 | 7.00 | 6.90 | 6.70 | 7.15 | 7.34 | |
| 7 | 7 | Steer | Control | 6.51 | 7.08 | 7.08 | 7.40 | 7.18 | 7.51 | |
| 8 | 8 | Steer | Control | 6.45 | 5.95 | 6.48 | 7.59 | 7.38 | 7.28 | |
| 9 | 9 | Steer | Control | 6.41 | 6.51 | 7.67 | 6.30 | 6.85 | 6.95 | |
| 10 | 10 | Steer | Control | 5.26 | 6.58 | 7.08 | 7.36 | 7.26 | 6.60 | |
| 11 | 11 | Steer | Control | 6.00 | 7.36 | 7.43 | 6.48 | 7.30 | 7.32 | 7.231035 |
| 12 | 1 | Heifer | Bovamine | 5.31 | 6.26 | 6.78 | 7.28 | 7.49 | 7.63 | |
| 13 | 2 | Heifer | Bovamine | 5.70 | 7.56 | 7.69 | 6.91 | 6.85 | 6.30 | |
| 14 | 3 | Heifer | Bovamine | 4.45 | 6.08 | 7.40 | 7.29 | 7.26 | 7.08 | |
| 15 | 4 | Heifer | Bovamine | 4.51 | 6.32 | 7.23 | 7.50 | 7.93 | 7.40 | |
| 16 | 5 | Heifer | Bovamine | 6.34 | 6.32 | 6.95 | 7.13 | 7.64 | 7.53 | |
| 17 | 6 | Steer | Bovamine | 5.51 | 6.20 | 7.38 | 7.51 | 7.36 | 7.89 | |
| 18 | 7 | Steer | Bovamine | 6.45 | 7.23 | 7.62 | 7.15 | 7.23 | 8.04 | |
| 19 | 8 | Steer | Bovamine | 5.48 | 6.85 | 6.78 | 7.03 | 6.85 | 7.28 | |
| 20 | 9 | Steer | Bovamine | 5.36 | 6.36 | 7.38 | 6.93 | 6.90 | 7.30 | |
| 21 | 10 | Steer | Bovamine | 5.11 | 6.81 | 7.11 | 7.27 | 7.26 | 6.70 | |
| 22 | 11 | Steer | Bovamine | 6.58 | 6.18 | 8.10 | 7.51 | 7.64 | 7.20 | 7.305405 |
| 23 | 1 | Heifer | Non-cap | 4.08 | 6.08 | 6.78 | 7.25 | 6.90 | 7.45 | |
| 24 | 2 | Heifer | Non-cap | 3.70 | 7.08 | 7.52 | 7.55 | 7.45 | 7.63 | |
| 25 | 3 | Heifer | Non-cap | 4.88 | 6.23 | 7.04 | 7.26 | 7.76 | 7.94 | |
| 26 | 4 | Heifer | Non-cap | 4.68 | 6.92 | 6.90 | 7.52 | 6.78 | 6.78 | |
| 27 | 5 | Heifer | Non-cap | 5.39 | 6.56 | 6.30 | 6.73 | 6.95 | 7.28 | |
| 28 | 6 | Steer | Non-cap | 6.11 | 6.26 | 6.90 | 6.91 | 7.54 | 7.34 | |
| 29 | 7 | Steer | Non-cap | 5.04 | 7.34 | 8.34 | 7.22 | 6.60 | 6.48 | |
| 30 | 8 | Steer | Non-cap | 6.70 | 6.30 | 7.00 | 7.06 | 7.15 | 7.23 | |
| 31 | 9 | Steer | Non-cap | 6.69 | 6.04 | 7.18 | 6.96 | 7.18 | 7.53 | |
| 32 | 10 | Steer | Non-cap | 6.36 | 7.15 | 6.48 | 6.65 | 6.85 | 7.40 | |
| 33 | 11 | Steer | Non-cap | 5.86 | 7.30 | 6.85 | 7.04 | 6.78 | 7.95 | |
| 34 | 12 | Steer | Non-cap | 6.26 | 6.56 | 7.04 | 7.29 | 6.70 | 7.53 | 7.378111 |
| 35 | 1 | Heifer | Microcap | 5.17 | 5.78 | 6.85 | 7.27 | 6.85 | 7.26 | |
| 36 | 2 | Heifer | Microcap | 4.81 | 5.85 | 6.60 | 6.79 | 7.11 | 7.26 | |
| 37 | 3 | Heifer | Microcap | 4.61 | 5.95 | 6.60 | 6.92 | 7.04 | 7.40 | |
| 38 | 4 | Heifer | Microcap | 4.20 | 5.78 | 6.60 | 7.21 | 7.45 | 7.51 | |
| 39 | 5 | Heifer | Microcap | 4.56 | 5.90 | 6.90 | 7.08 | 7.34 | 6.70 | |
| 40 | 6 | Steer | Microcap | 6.43 | 6.08 | 6.48 | 6.70 | 6.18 | 6.95 | |
| 41 | 7 | Steer | Microcap | 6.36 | 6.72 | 6.70 | 7.11 | 7.20 | 7.58 | |
| 42 | 8 | Steer | Microcap | 6.23 | 6.51 | 7.54 | 7.18 | 7.38 | 7.69 | |
| 43 | 9 | Steer | Microcap | 6.57 | 6.60 | 6.85 | 6.30 | 6.48 | 7.64 | |
| 44 | 10 | Steer | Microcap | 6.02 | 6.72 | 6.30 | 7.49 | 7.00 | 7.23 | |
| 45 | 11 | Steer | Microcap | 6.29 | 6.08 | 7.46 | 6.80 | 6.85 | 8.37 | 7.41602 |

### Example 6

### Effects of Probiotics on E. coli O157:H7 Colonization in Rectal Tissue

Four cattle (2 heifers and 2 steers) were selected to represent low and high shedding of E. coli O157:H7 from each treatment. Rectal biopsies were surgically collected at 44 days p.i. at the Dept. of Veterinary Medicine and Surgery, University of Missouri. Biopsy samples were clamped twice at approximately 1 to 10 cm adjacent to the recto-anal junction (RAJ) along the terminal rectum, washed three times with phosphate-buffered saline (PBS, pH 7.4), and fixed in 4% formaldehyde in PBS for 24 hours.

Formalin-fixed tissues were embedded in paraffin wax and cut at 6-μm section. The attachment of E. coli O157:H7 was detected using immunofluorescence microscopy. The selected tissues were immunostained with a goat anti-O157 polyclonal antibody labeled with fluorescein isothiocyanate (Kirkegaard & Perry Laboratories, Inc., Gaithersburg, Md.) according to Naylor et al. (Infection and Immunity 71:1505-1512, 2003) with minor modifications (1:100 for 30 minutes at room temperature). The fixed tissue was incubated with the specific antibody diluted in PBS containing 0.5% Triton X-100 for 30 minutes at 37° C., and the tissue, counterstained with tetramethyl rhodamine isothiocyanate (TRITC)-phalloidin, were observed with a Zeiss LSM510 confocal microscopy.

Biopsies taken from the terminal rectum were immunostained to determine the localization of E. coli O157:H7. Colonization of E. coli O157:H7 was clearly observed on the epithelial surface of the terminal rectum using confocal scanning microscope. Significant differences were observed between low and high shedding of E. coli O157:H7. Microcolonies of E. coli O157:H7 were observed on the rectal biopsies collected from cattle shedding high numbers of E. coli O157:H7 (>2.0 log CFU/g) on 44 days p.i., while no fluorescence was detected on rectal tissues collected from cattle which were E. coli O157:H7 negative by enrichment culture. E. coli O157:H7 colonization was positive at the proximal and adjacent distances from the RAJ. The colonization positives were observed in fecal shedding populations of 3 log CFU/g, whereas the negatives were less than 1.0 log CFU/g. Cattle (H2266) shed high number of E. coli O157:H7 at 44 days p.i., and E. coli O157:H7 was localized along its terminal rectum. High and long-term shedding of E. coli O157:H7 (H2375, H2362, and S2329) was closely related to colonization in the terminal rectum. E. coli O157:H7 colonization was primarily located within 10 cm adjacent to RAJ along the terminal rectum.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for delivering probiotic bacteria to the gastrointestinal tract of a ruminant animal comprising providing at least one probiotic bacterium encapsulated in carrageenan in the diet of a ruminant animal.

2. The method of claim 1, comprising delivering the probiotic bacteria to the post rumen portion of the gastrointestinal tract of the ruminant animal.

3. The method of claim 2, comprising delivering the probiotic bacteria to the recto-anal junction of the gastrointestinal tract of the ruminant animal.

4. The method of claim 1, wherein the probiotic bacteria comprise bacteria from at least one species selected from the group consisting of: Lactobacillus paracasei, Lactobacillus acidophilus, Lactobacillus rhamnosus, Bifidobacterium animalis and Bifidobacterium bifidum.

5. The method of claim 4, wherein the probiotic bacteria comprise Lactobacillus paracasei or Bifidobacterium animalis bacteria.

6. The method of claim 4, wherein the probiotic bacteria comprise Lactobacillus paracasei and Bifidobacterium animalis bacteria.

7. The method of claim 1, wherein the delivery of the probiotic bacteria to the gastrointestinal tract of the ruminant animal reduces E. coli colonization in the gastrointestinal tract.

8. The method of claim 7, wherein the E. coli is E. coli O157:H7.

9. The method of claim 1, wherein the ruminant animal is selected from the group consisting of a cow, a goat, a sheep and a deer.

10. The method of claim 9, wherein the ruminant animal is a cow.

11. The method of claim 1, wherein the probiotic bacteria are suspended in a saline solution.

12. The method of claim 1, wherein the probiotic bacteria are spread on the top of the daily feed of the ruminant animal.

13. The method of claim 1, wherein the probiotic bacteria are provided in the diet of the ruminant animal at about 10¹⁰ colony forming units (CFU) per day.

14. The method of claim 1, comprising delivering the probiotic bacteria for between 2 and 44 days.

15. The method of claim 1, wherein the probiotic bacteria are provided in the diet of the ruminant animal prior to slaughter.

16. A method of reducing E. coli in the gastrointestinal tract of a ruminant animal comprising delivering at least one probiotic bacterium encapsulated in carrageenan in the diet of a ruminant animal.

17. The method of claim 16, wherein the probiotic bacteria are delivered to the post rumen portion of the gastrointestinal tract of the ruminant animal.

18. The method of claim 17, wherein the probiotic bacteria are delivered to the recto-anal junction of the gastrointestinal tract of the ruminant animal.

19. The method of claim 16, wherein the probiotic bacteria comprise bacteria from at least one species selected from the group consisting of: Lactobacillus paracasei, Lactobacillus acidophilus, Lactobacillus rhamnosus, Bifidobacterium animalis, and Bifidobacterium bifidum.

20. The method of claim 19, wherein the probiotic bacteria comprise Lactobacillus paracasei or Bifidobacterium animalis bacteria.

21. The method of claim 19, wherein the probiotic bacteria comprise Lactobacillus paracasei and Bifidobacterium animalis bacteria.

22. The method of claim 16, wherein the ruminant animal is selected from the group consisting of a cow, a goat, a sheep and a deer.

23. The method of claim 22, wherein the ruminant animal is a cow.

24. The method of claim 16, wherein the probiotic bacteria are suspended in a saline solution.

25. The method of claim 16, wherein the probiotic bacteria are spread on the top of the daily feed of the ruminant animal.

26. The method of claim 16, wherein the probiotic bacteria are provided in the diet of the ruminant animal at about 10¹⁰ colony forming units (CFU) per day.

27. The method of claim 16, comprising delivering the probiotic bacteria for between 2 and 44 days.

28. The method of claim 16, wherein the probiotic bacteria are provided in the diet of the ruminant animal prior to slaughter.

29. The method of claim 16, wherein the E. coli is E. coli O157: H7.

30. A probiotic bacterial composition encapsulated in carrageenan for use in a ruminant animal.

31. The probiotic bacterial composition of claim 30, comprising bacteria from at least one species selected from the group consisting of: Lactobacillus paracasei, Lactobacillus acidophilus, Lactobacillus rhamnosus, Bifidobacterium animalis, and Bifidobacterium bifidum.

32. The probiotic bacterial composition of claim 31, comprising Lactobacillus paracasei or Bifidobacterium animalis bacteria.

33. The probiotic bacterial composition of claim 31, comprising Lactobacillus paracasei and Bifidobacterium animalis bacteria.

34. The probiotic bacterial composition of claim 30, wherein the probiotic bacterial composition functions to reduce colonization of E. coli in the gastrointestinal tract of the ruminant animal when provided in the diet of the ruminant animal.

35. The probiotic bacterial composition of claim 34, wherein the E. coli is E. coli O157:H7.

36. The probiotic bacterial composition of claim 30, wherein the ruminant animal is selected from the group consisting of a cow, a goat, a sheep and a deer.

37. The probiotic bacterial composition of claim 36, wherein the ruminant animal is a cow.

38. The probiotic bacterial composition of claim 30, wherein the probiotic bacterial composition is suspended in a saline solution.
